(19) United States
(12) Patent Application Publication
(10) Pub. No.: US 2010/0273136 A1
(43) Pub. Date: Oct. 28, 2010

(54) SVK'S REAL TIME TURP SIMULATOR

(76) Inventors: Sangampalyam Vedanayagam Kandasami, Coimbatore (IN); Venkata Ramana Murthy Kondagunturi, Hyderabad (IN)

Correspondence Address: BACHMAN & LAPOINTE, P.C., 900 CHAPEL STREET, SUITE 1201, NEW HAVEN, CT, 06510, US

(21) Appl. No.: 12/627,300

(22) Filed: Nov. 30, 2009

(30) Foreign Application Priority Data
Apr. 24, 2009 (IN) 949/CHE/2009

(51) Int. Cl. G09B 23/30

(52) U.S. Cl. 434/272

(57) ABSTRACT

An apparatus for training and developing existing and new interventional procedures on human prostate gland and urinary bladder, wherein the apparatus comprises a plurality of simulations of body structures, the simulations being a set of simulations of a particular part of the anatomy and being of increasing anatomical complexity and/or presenting increasing clinical or surgical difficulty, and a mechanism for receiving at least one of the simulations so that a surgical and/or a clinical technique may be practiced.

### BACKGROUND OF THE INVENTION

The present invention relates to prostate resection especially a training device which simulates a realistic environment for prostate resection.

The prostate is a male reproductive system gland that is generally made of three lobes that are enclosed by an outer layer of tissue referred to as the capsule. The prostate surrounds the lower portion of the bladder (where urine is stored) and part of the urethra (the canal through which urine passes from the bladder out of the body). Continued growth of the prostate causes Benign Prostatic Hypertrophy (BPH), where the continually growing prostate tissue squeezes the lower portion of the bladder and the urethra, making it difficult to pass urine. BPH is often treated by surgically removing the excess prostatic tissue from the interior region of the prostate that is pressing on the urethra, which usually relieves the obstruction and the incomplete emptying of the bladder caused by the BPH, leaving the rest of the prostatic tissue and the capsule intact.

Surgeons often perform transurethral surgery to remove the excess prostate tissue i.e.; the targeted prostatic tissue. This surgery is performed by inserting a resectoscope through the urethra. The resectoscope is used to view the interior of the urinary tract, and to cut (incise) off pieces of the targeted prostatic tissue. Following surgery, a urinary catheter is inserted into the urethra to drain urine from the bladder. This catheter is usually left in place until the presence of blood in the urine has diminished, usually within 1-4 days. There are several prostate resection procedures currently being used. The TURP procedure (transurethral resection of the prostate) is a very common treatment of BPH. During a TURP procedure, the surgeon uses a standard electrosurgical cutting loop to remove the obstructing tissue from the prostate. The electrosurgical cutting loop is inserted through the resectoscope to the targeted prostatic tissue. The electrosurgical cutting loop uses electricity to “shave” off small pieces of the targeted prostate tissue from the interior of the prostate. During surgery, the shaved pieces of prostatic tissue are carried by irrigation fluid flowing through the resectoscope into the bladder. At the end of the operation, these pieces of excised prostatic tissue are flushed out of the bladder using irrigant, aspirated out using a large bore syringe, and/or removed through the resectoscope using a grasping device.

Consequently, a major problem encountered in the development of the above-mentioned surgical processes is the training of surgeons. It is critical that physicians are required to precisely control the three-dimensional movements of surgical instruments inside a patient while observing two-dimensional images from the endoscope on a monitor. Such movements can be quite demanding due to problems with orientation and hand-eye coordination. Thus, it is highly desirable that the skills for performing such surgeries are developed using a simulator which provide realistic visual and tactile feedback during training in order to make this training most effective.

Usually, physicians receive training in such endoscopic techniques by practicing on animal models. Such methods are disadvantageous, however, because animal models are expensive, and practicing on animals generally requires an operating room, surgical and anesthetic equipment, and the appropriate certificates and registrations. Moreover, using animals to practice surgical skills is ethically debatable and they do not mimic or simulate the histoarchitecture of human organs.

Other such training methods involve the use of cadavers. However, like animal models, the use of cadavers can be expensive. Further, the properties of cadaver tissue differ from those of living tissue, for example, the absence of bleeding in cadaver tissue. Thus, practicing these surgical procedures on cadavers can be unrealistic.

Historically the simulators have a virtual reality component where the projected digital video clips create the surgical atmosphere without any real sensation of touch and tissue feel. These are driven by mainly software. The training on these simulators will not give the real feel for the control of the surgical instruments with regards to the depth of cut, coagulation and tissue drag. Unless one has an idea of these specific real time movements of the surgical instrument, such as loops, laser fibers etc., within the endoscopic confines, it would be difficult to perform with accurate movements during real time surgeries.

This new simulator will give the opportunity to the young surgeons and trainees to get a real time feel of the prostate and bladder procedures by which surgeons to perform these tasks efficiently.

### SUMMARY OF THE INVENTION

The present invention is an improved simulator which allows the trainees and surgeons to work in a realistic environment as the simulations are so designed that commonly are encountered and important forms of pathology, and variations in anatomy, which a surgeon may expect to meet in the performance of an operation, prostate resection for example, are incorporated. It consists of all the anatomical land marks, surgical boundaries, and possible procedural complications during prostate resection performed through the urethral route. It also provides mechanisms to position the object-simulation to resemble real life conditions, giving the surgeons a tactile feedback and again provides easy access for set-up and checking by a supervising trainer.

### BRIEF DESCRIPTION OF THE DRAWINGS

Other aspects and features of the present invention will become apparent by a review of the specification, claims and appended figures.

FIG. 1: Simulator assembly

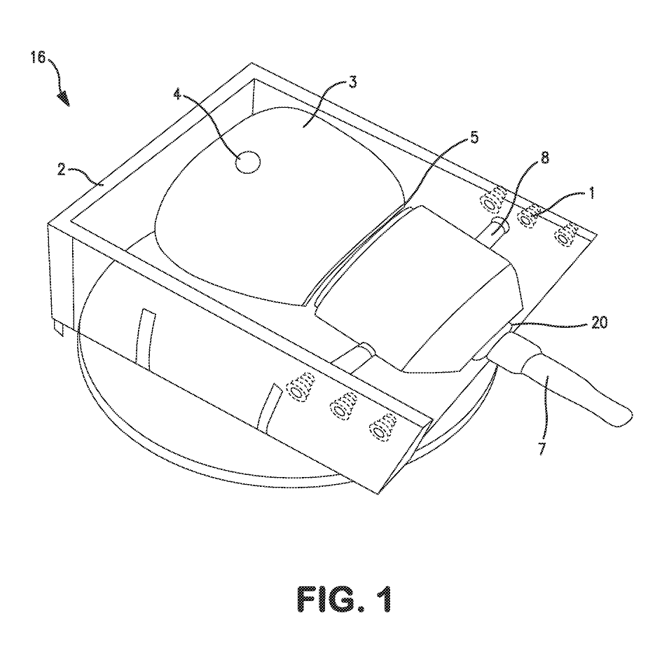

FIG. 2: Simulator external side view.

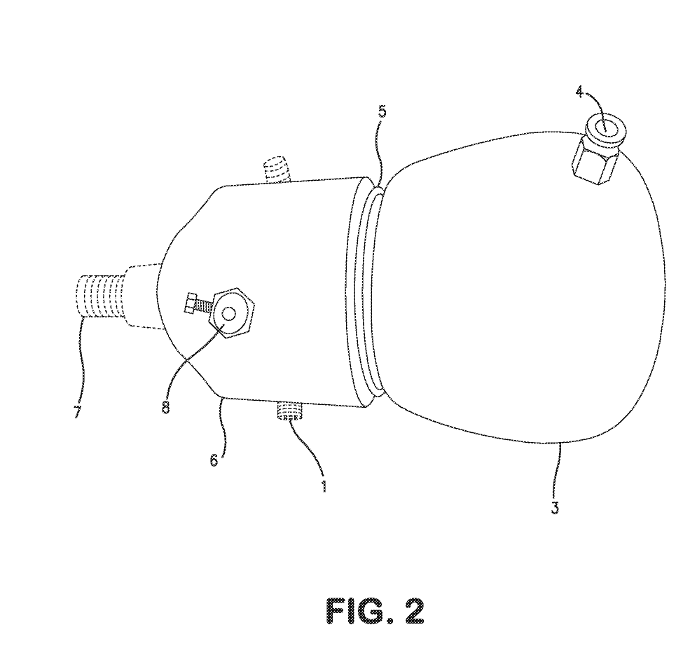

FIG. 3: Prostate part side view

FIG. 4: Prostate part Top view

FIG. 5: Metal Cylinder side view

FIG. 6: Prostate mould preparation

FIG. 7: Prostate mould in the Metal cylinder

FIG. 8: Bladder Part side view

FIG. 9: Acrylic box to accommodate the Simulator

### DETAILED DESCRIPTION

The following specification particularly describes the nature of invention and the manner to which it is to be performed.

The components of the SVK's Real Time TURP Simulator are a preformed prostate mould, metal cylinder, prostatic fossa (module), urinary bladder part and a vascular flow part. The simulators of the present invention provide a cavity that is a simulation of a cavity in which an operational procedure is performed. Each of the simulators is an ergonomically shaped container that has a cavity for mounting an object within on which a surgical procedure will be practiced by an individual.

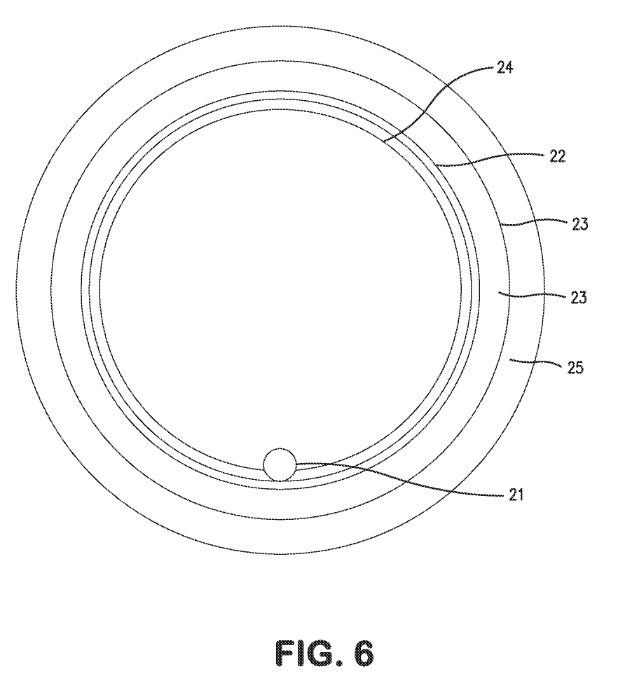

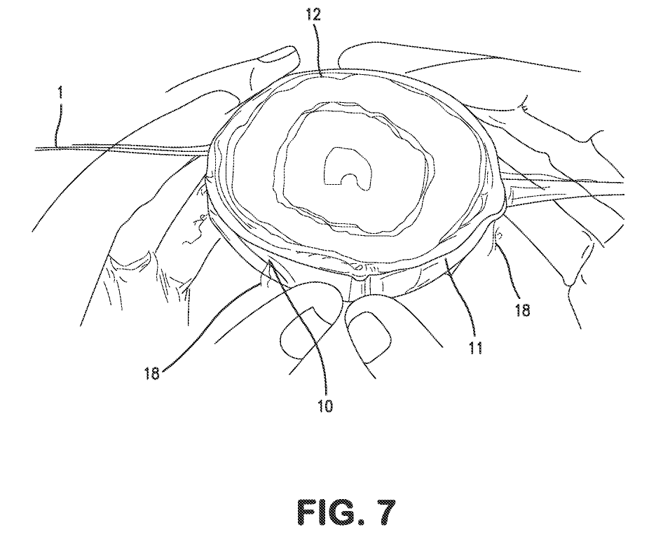

In a preferred embodiment of the present invention the prostate, uterine or rectal mould (FIGS. 6 and 7) is made of fresh bovine liver. This mould has a facility to identify the surgical capsule during resection. A rectangular piece of bovine liver measuring approximately 10×6 cm with thickness of up to 2 cm is taken and rolled to fit the inside of the prostate fossa module, which itself is re-usable. A coloured bead is sutured in the middle about 2 cm from the margin to act as the verumontanum and marks the safe distal end of the planned resection. The back of the liver is bivalved at or distal to the level of so-called veru. An elastic ring with variable tension strength, when applied on the rolled tissue preparation simulates the compression forces of the external sphincter. A rectangular piece of bovine omentum which is cut to the size of original prostatic mould is then wrapped around the rolled “prostatic” tissue which acts as the surgical capsule. This is covered with another thinner but same size piece of bovine liver soaked in methylene blue, which acts as peripheral zone and residual prostatic tissue. The proximal portion of the inner mould of tissue is everted to simulate the bladder neck. The inner aspect of the rolled tissue simulates the lateral lobes and the prostatic urethra. The mould can be made to different sizes and shapes to simulate different sized prostates, as one comes across in the real life situation as well as to simulate a uterus or rectum.

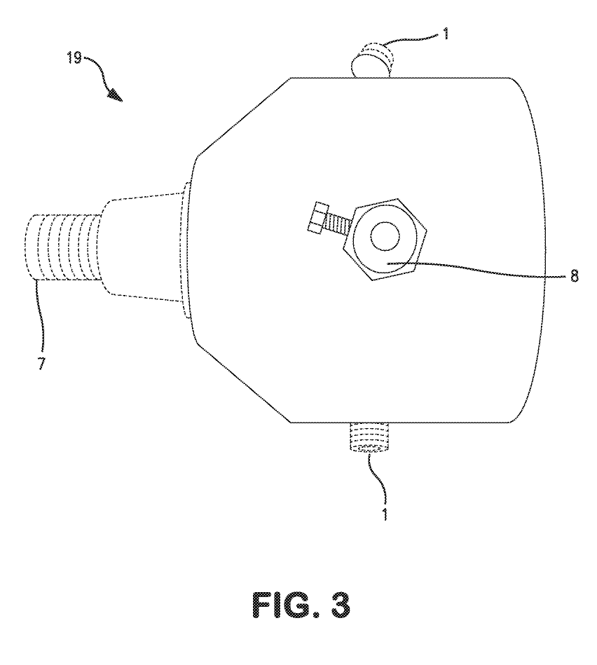

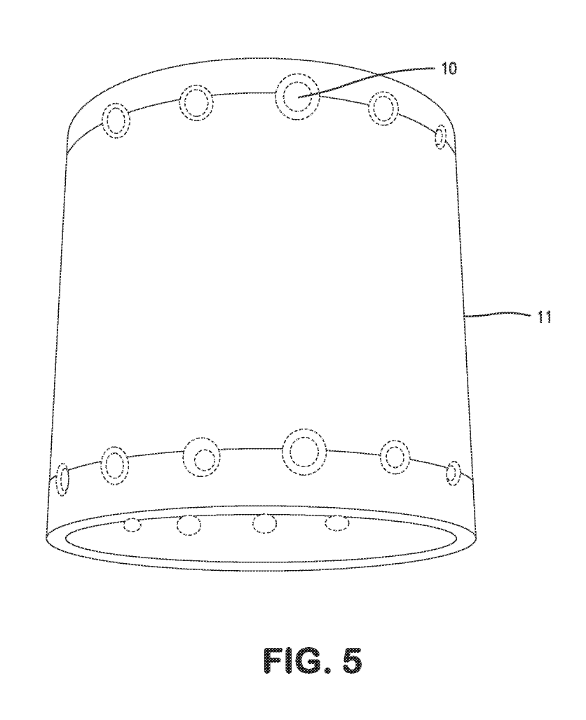

A metal cylinder (FIG. 5) having the dimension of outer surface of prostatic fossa and the pre formed “prostate” tissue mould fits into this snugly. This cylinder has multiple fenestrations (FIG. 5) and/or a longitudinal ridge on its rotational axis. The former allows the entry of epidural catheters (Vascular inlet of FIG. 3) and also helps to place sutures to secure the prostate mould in position thus preventing movement during resection. It has a provision for external earth plate connection to facilitate monopolar high frequency current usage. The longitudinal ridge fits into the grove on the inner surface of the prostate fossa module so that the entire unit is immobilized. It may be disposable or reusable.

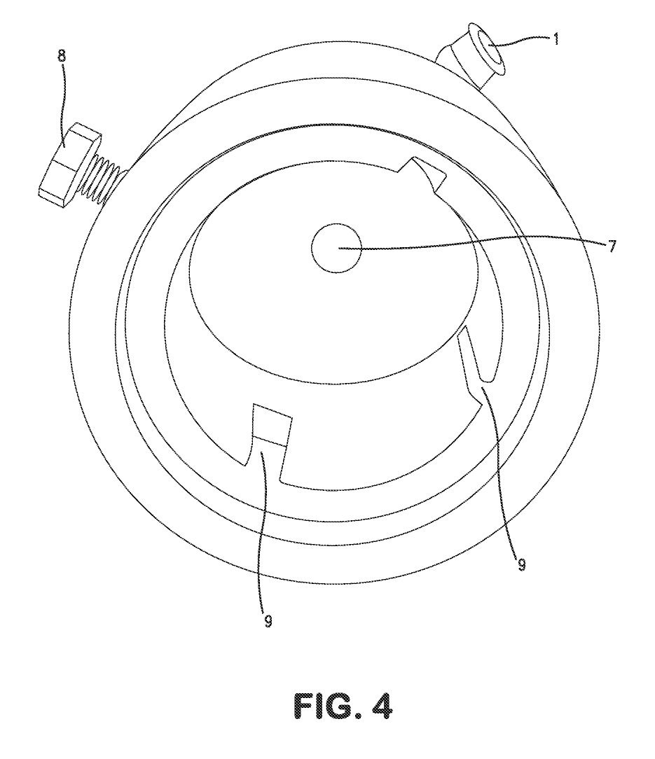

The prostate fossa module (FIGS. 3 and 4) is made of synthetic non-resilient material. The inner surface of the fossa has a grove (FIG. 4) into which the copper cylinder containing the prostate mould fits snugly. Additional grooves to accommodate the epidural catheters are present on either side. The outer surface on its rotational axis has ports (Electrode connection in FIGS. 3 and 4) with water tight seals to pass the earth plate cable for monopolar resection and to pass epidural catheters carrying liquid to simulate bleeding. The bottom of the prostate fossa module has water tight seal (Resectoscope inlet portion of FIG. 3) which allows a to and fro movement of the resectoscope much like the resectoscope movement in the human urethra. Continuous flow resectoscopes can be used for the training.

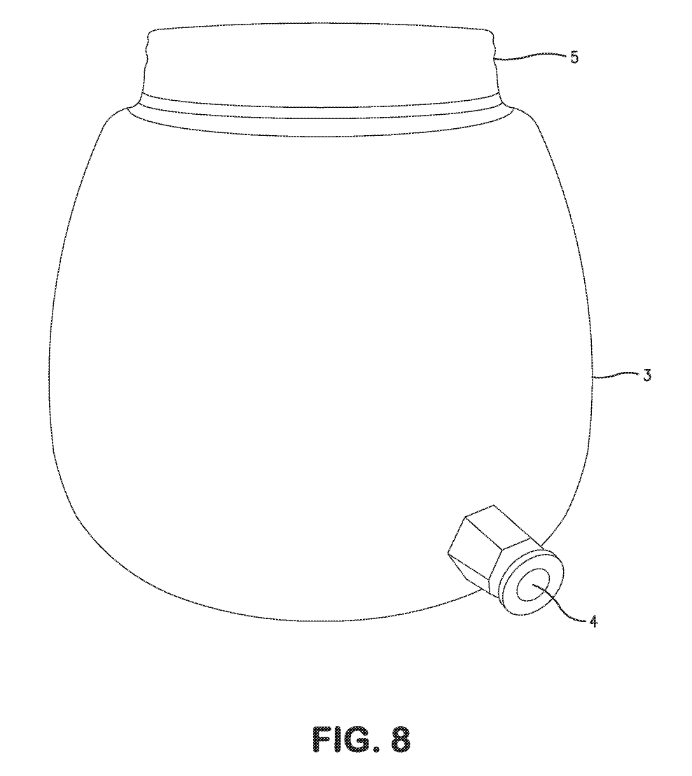

A simulated vessel which simulates the urinary bladder called as the urinary bladder part (FIG. 8) is also made of synthetic non-resilient material like the prostate fossa module. It has an outlet (FIG. 8) for the irrigation fluid flow. This outlet for the bladder part helps to drain the irrigation solution. This arrangement makes the trainee use the irrigation just like in real time making assessment of probable complications possible. The bladder and the prostatic fossa parts have markers for 12 ‘o’ clock orientation to facilitate proper interlocking. The alignment of these markers for prostate and bladder part will guide the surgeon to get proper orientation.

The vascular part (FIGS. 3, 4 and 9) consists of epidural catheters (or similar non-metallic tubing) which are placed in the strategic points in the prostate mould and brought via the copper cylinder and the inlets of the prostatic fossa to the exterior. They are connected externally either to a pressure regulated (adjustable) chamber or to syringes containing colored liquid or citrated blood. Injection of colored fluid or citrated blood slowly or in a pulsatile fashion as desired simulates venous and arterial bleeding respectively.

This completed unit is placed on a plastic box and is ready to perform resection using the appropriate energy source such as Monopolar or Bipolar RF, or Laser.

In another embodiment of the present invention the prostate, uterine ore rectal mould (FIG. 6) is made of synthetic tissue module with sensors placed in the surgical capsular plane. The elastic non conductive band which acts as an external sphincter simulator is superimposed with a conductive material. This will be used to measure the number of times the resection loop or laser fiber touches this area. Delivery of energy to this area in real life will damage the sphincter of the patient, which in turn can produce a complication called incontinence. A safe resection will never touch the sphincter part.

This system further comprises of an external analyzer unit into which the feedback from the conductive material can be fed which helps to warn the trainee when any damage to the sphincter is made during the procedure.

A metal cylinder (FIG. 5) having the dimension of outer surface of prostatic fossa and the pre formed “prostate tissue” mould fits into this snugly. This cylinder has multiple fenestrations (FIG. 5) and/or a longitudinal ridge on its rotational axis. The former allows the entry of epidural catheters and also helps to place sutures to secure the prostate mould in position thus preventing movement during resection. It has a provision for external earth plate connection to facilitate monopolar high frequency current usage. The longitudinal ridge fits into the grove on the inner surface of the prostate fossa module so that the entire unit is immobilized. It may be disposable or re-usable.

The prostate fossa module (FIG. 4) is made of synthetic non-resilient material. The inner surface of the fossa has a grove (FIG. 4) into which the copper cylinder containing the prostate mould fits snugly. Additional grooves to accommodate the epidural catheters are present on either side. The outer surface on its rotational axis has ports (FIG. 4) with water tight seals to pass the earth plate cable for monopolar resection and to pass epidural catheters carrying liquid to simulate bleeding. The bottom of the prostate fossa module has water tight seal ( ) which allows a to and fro movement of the resectoscope much like the resectoscope movement in the human urethra. Continuous flow resectoscopes can be used for the training.

A simulated vessel which simulates the urinary bladder called as the urinary bladder part (FIG. 8) is also made of resilient component resembling the normal urinary bladder to simulate the full and empty bladder. Resilient bladder part will be used for attaching the synthetic or the biological tissue preparation to simulate transurethral procedures for bladder tumors.

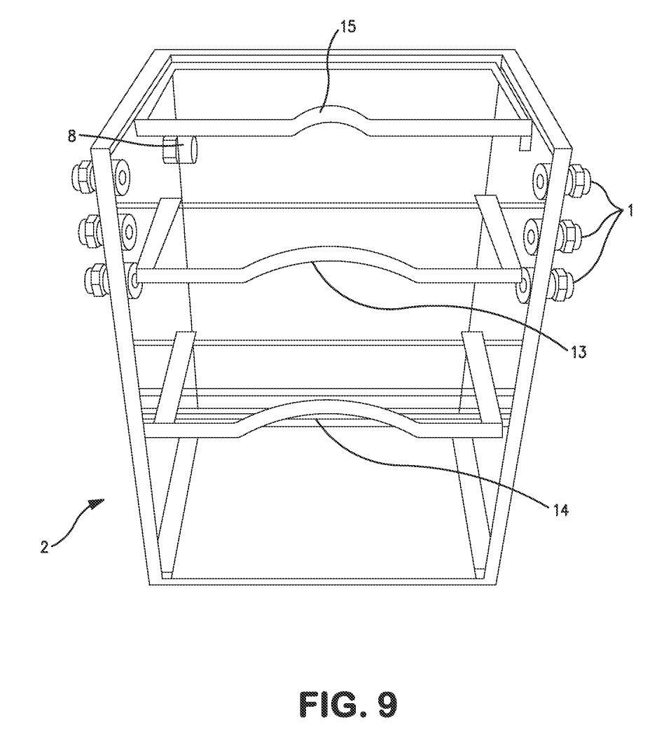

The vascular part (FIGS. 4 and 9) consists of epidural catheters (or similar non-metallic tubing) ( ) which are placed in the strategic points in the prostate mould and brought via the copper cylinder and the inlets of the prostatic fossa to the exterior. They are connected externally either to a pressure regulated chamber or to syringes containing colored liquid or citrated blood. Injection of colored fluid or citrated blood slowly or in a pulsatile fashion as desired simulates venous and arterial bleeding respectively.

This completed unit is placed on a plastic box and is ready to perform resection using the appropriate energy source such as heat, laser or ultrasound.

According another embodiment of the present inventions completed unit, a transurethral ultrasound transducer can also be used which can be used to calculate the volume of the tissue to be removed for a robotic tissue removal procedure. This is a robotic arm with movements in in longitudinal (base to apex), transverse (left to right) and antero-posterior axes, with an integrated ultrasound transducer for image guidance and targeting plan and automate the procedure.

According to another preferred embodiment of the present invention the resectoscope with the surgical loop is inserted in—which can be viewed in on the video monitor. Resectoscope movements to and fro and rotation are allowed and resemble the real time situation. As the provisions for identifying the bladder neck, external sphincter and the verumontanum was given resection can be practiced as in a true situation like in a patient who requires a prostate gland resection/enucleation or vaporization. The cut portions of targeted tissue are drawn into and through the aspiration channel at the end of the procedure using an Ellick evacuator or Toomy syringe like in a normal surgical procedure. A provision was given to warn (visual and auditory) the trainee if the sphincter damage was imminent. Learning this part of resection eliminates a serious complication when the procedure is done on a patient.

This simulator thereby provides the various parameters such as time vs. the gland size, time vs. the energy, blood loss estimate, sphincter damage/preservation, irrigation fluid volume, absorbed fluid volume estimation, channel size assessment, control of bleeders, and identification of end point of resection (surgical capsule).

Therefore the simulator, according to the invention, may be used for teaching persons who are not specialists in the field such as workers in various medical equipment dealers, can be used to develop newer technologies to deal with prostate resection, validate the newer medical equipments/energies to be used on prostate gland, apart from training the surgical students.

While the invention has been described with reference to various embodiments, those skilled in the art will appreciate that certain substitutions, alterations and omissions may be made to the embodiments without departing from the scope of the invention. Accordingly, the foregoing description is meant to be exemplary only, and should not limit the scope of the invention as set forth in the following claims.

1-25. (canceled)

26. An apparatus for clinical or surgical procedure for the treatment of prostatic disorders, comprising:
(a) a preformed prostate mold;
(b) a metal cylinder;
(c) a prostate fossa;
(d) a urinary bladder part; and
(e) a vascular flow part.

27. The apparatus of claim 26, wherein the prostatic fossa accommodates a metal cylinder which acts as conductor of energy and contains a prostate mold.

28. The apparatus of claim 27, wherein the prostate mold is made of a biological or a synthetic tissue to simulate a prostate and comprises a landmark of a prostate.

29. The apparatus of claim 28, wherein the simulated prostatic mold is positioned into an interior cavity in an anatomically correct manner.

30. The apparatus of claim 28, wherein the landmark is a sphincter.

31. The apparatus of claim 28, further including synthetic blood.

32. The apparatus of claim 29, wherein the simulated prostatic mold comprises a vascular part which has pressure regulated liquid flow channels to regulate flow rate of a fluid which resembles bleeding.

33. The apparatus of claim 32, further comprising a plurality of synthetic anatomical structures for selective dissection thereby preserving the integrity of the prostate.

34. The apparatus of claim 26, wherein an earth plate cable passing through the prostate fossa mold uses various forms of energy as monopolar, bipolar, laser to resect the tissue.

35. A method to train surgeons on a surgical or clinical procedure, comprising:
(a) a biological or synthetic tissue;
(b) positioning the said biological or synthetic tissue in a mold which facilitates to identify the surgical capsule;
(c) joining the mold to a vascular part which has a pressure regulated liquid flow to simulate bleeding from an organ;
(d) providing a reservoir which contains a volume of fluid and inlet tubing extending from said reservoir to an inlet of said vascular part;
(e) providing means for conducting a resectoscope to the said biological or synthetic tissue whose to and fro movements resemble that of a real time situation; and
(f) conducting a surgical or clinical procedure on the said biological or synthetic tissue.
